(19) United States
(12) Patent Application Publication
(10) Pub. No.: US 2014/0215798 A1
(43) Pub. Date: Aug. 7, 2014

(54) SYSTEM AND METHOD FOR INSTALLING A SEAL ON A WORK PIECE

(71) Applicant: ELLCON NATIONAL, INC., Greenville, SC (US)

(72) Inventors: Phillip E. Reece, Greenville, SC (US); Norman E. Boyter, Greenville, SC (US)

(73) Assignee: Ellcon National, Inc., Greenville, SC (US)

(21) Appl. No.: 13/759,539

(22) Filed: Feb. 5, 2013

(51) Int. Cl. B23P 19/04

(52) U.S. Cl. CPC B23P 19/04
USPC 29/450; 29/235

(57) ABSTRACT

A system for installing a seal on a work piece includes a stretcher tool having a tapered end, an outer diameter opposite the tapered end, and an axial bore. A collar has an inner diameter greater than the outer diameter, and the collar is adapted to slide over the outer diameter to push the seal over the outer diameter. A method for installing a seal on a work piece includes placing the seal on a stretcher tool, wherein the stretcher tool has a tapered end, an outer diameter opposite the tapered end, and a stretcher axial bore. The method further includes sliding a collar over the tapered end and the outer diameter, engaging the collar against the seal, and sliding the collar over the outer diameter to push the seal into a first groove in the work piece.

### FIELD OF THE INVENTION

The present invention relates generally to a system and method for installing a seal on a work piece.

### BACKGROUND OF THE INVENTION

Seals are commonly used in various mechanical applications to prevent leakage and/or exclude contamination between rotating and/or reciprocating components without creating excessive friction between the components. For example, an annular lip seal is commonly used with drive shafts, axles, motors, pumps, gearboxes, pistons, and similar work pieces to fill the relatively tight clearance between rotating and/or reciprocating components. In some cases, the seal may be asymmetrical, with a different shape or profile on one or more surfaces to enhance the low friction barrier between the work pieces.

The generally elastic nature of the seal and/or the relatively tight clearance between the work pieces may make installation of the seal difficult, and improper installation of the seal may adversely affect the performance and/or service life of the seal and/or work piece. For example, the ability of the seal to provide a low friction barrier may be substantially compromised if the seal twists, rolls, inverts, or otherwise distorts during installation. This is particularly true in the case of an asymmetric seal with specific shapes or profiles selected to match each component surface. Therefore, an improved system and method for installing a seal on a work piece that reduces twisting, rolling, and/or other distortions of the seal during installation would be useful.

### BRIEF DESCRIPTION OF THE INVENTION

Aspects and advantages of the invention are set forth below in the following description, or may be obvious from the description, or may be learned through practice of the invention.

One embodiment of the present invention is a system for installing a seal on a work piece. The system includes a stretcher tool, a tapered end of the stretcher tool, a stretcher outer diameter opposite the tapered end, and a stretcher axial bore opposite the tapered end. A collar has a collar inner diameter greater than the stretcher outer diameter, and the collar is adapted to slide over the stretcher outer diameter to push the seal over the stretcher outer diameter.

Another embodiment of the present invention is a system for installing first and second seals in first and second grooves, respectively, on a work piece. The system includes a first stretcher tool having a first tapered end, a first stretcher outer diameter opposite the first tapered end, and a first stretcher axial bore opposite the first tapered end. A second stretcher tool has a second tapered end, a second stretcher outer diameter opposite the second tapered end, and a second stretcher axial bore opposite the second tapered end. A first collar has a first collar inner diameter greater than the first stretcher outer diameter, and a second collar has a second collar inner diameter greater than the second stretcher outer diameter. The first stretcher outer diameter is greater than the second stretcher outer diameter. The first collar is adapted to slide over the first stretcher outer diameter to push the first seal over the first stretcher outer diameter, and the second collar is adapted to slide over the second stretcher outer diameter to push the second seal over the second stretcher outer diameter.

Another embodiment of the present invention is a method for installing a seal on a work piece. The method includes placing the seal on a stretcher tool, wherein the stretcher tool has a tapered end, a stretcher outer diameter opposite the tapered end, and a stretcher axial bore opposite the tapered end. The method further includes sliding a collar over the tapered end and the stretcher outer diameter, engaging the collar against the seal, and sliding the collar over the stretcher outer diameter to push the seal over the stretcher outer diameter and into a first groove in the work piece.

Those of ordinary skill in the art will better appreciate the features and aspects of such embodiments, and others, upon review of the specification.

### BRIEF DESCRIPTION OF THE DRAWINGS

A full and enabling disclosure of the present invention, including the best mode thereof to one skilled in the art, is set forth more particularly in the remainder of the specification, including reference to the accompanying figures, in which:

FIG. 1 is a perspective view of a system for installing a seal on a work piece according to one embodiment of the present invention;

FIG. 2 is a side plan view of the stretcher tool and collar shown in FIG. 1;

FIG. 3 is a top plan view of the system shown in FIG. 1;

FIG. 4 is a cross-section view of the system shown in FIG. 1 taken along line A-A during installation of the seal on the stretcher tool;

FIG. 5 is a cross-section view of the system shown in FIG. 1 taken along line A-A during installation of the seal on the work piece;

FIG. 6 is a detail view of a portion of the seal shown in FIG. 5 aligned with a groove in the work piece;

FIG. 7 is a detail view of a portion of the seal shown in FIG. 5 inserted into the groove in the work piece;

FIG. 8 is a perspective view of a system for installing a seal on a work piece according to an alternate embodiment of the present invention;

FIG. 9 is a top plan view of the system shown in FIG. 8;

FIG. 10 is a cross-section view of the system shown in FIG. 9 taken along line B-B during installation of the seal on the stretcher tool;

FIG. 11 is a cross-section view of the system shown in FIG. 9 taken along line B-B during installation of the seal on the work piece;

FIG. 12 is a detail view of a portion of the seal shown in FIG. 11 aligned with a groove in the work piece; and

FIG. 13 is a detail view of a portion of the seal shown in FIG. 11 inserted into the groove in the work piece.

### DETAILED DESCRIPTION OF THE INVENTION

Reference will now be made in detail to present embodiments of the invention, one or more examples of which are illustrated in the accompanying drawings. The detailed description uses numerical and letter designations to refer to features in the drawings. Like or similar designations in the drawings and description have been used to refer to like or similar parts of the invention. As used herein, the terms “first”, “second”, and “third” may be used interchangeably to distinguish one component from another and are not intended to signify location or importance of the individual components. The terms “upstream,” “downstream,” “radially,” and “axially” refer to the relative direction with respect to fluid flow in a fluid pathway. For example, “upstream” refers to the direction from which the fluid flows, and “downstream” refers to the direction to which the fluid flows. Similarly, “radially” refers to the relative direction substantially perpendicular to the fluid flow, and “axially” refers to the relative direction substantially parallel to the fluid flow.

Each example is provided by way of explanation of the invention, not limitation of the invention. In fact, it will be apparent to those skilled in the art that modifications and variations can be made in the present invention without departing from the scope or spirit thereof. For instance, features illustrated or described as part of one embodiment may be used on another embodiment to yield a still further embodiment. Thus, it is intended that the present invention covers such modifications and variations as come within the scope of the appended claims and their equivalents.

Various embodiments of the present invention include a system and method for installing a seal on a work piece. The system and method generally include one or more tools and/or adapters that may be used to stretch the seal and slide the seal into a groove in the work piece. In particular embodiments, for example, the seal may be placed on a stretcher tool that expands the diameter of the seal, and a collar may be slid over the stretcher tool to push the seal along the stretcher tool and into position in the groove. In other particular embodiments, the system and method may include a platform to position and/or hold the work piece, and the platform may include a surface that is substantially co-planar with the groove to facilitate locating the seal in the groove. Alternately or in addition, the platform may include reciprocating members that may close against the work piece to provide a surface that is substantially co-planar with a second or different sized groove to facilitate locating a second or different sized seal in the second groove. Although exemplary embodiments describe and illustrate the work piece as a rotary component, one of ordinary skill in the art will readily appreciate from the teachings herein that the present invention may be applied to reciprocating work pieces, vibrating work pieces, stationary work pieces, and/or any work piece that includes a seal, and the present invention is not limited to a rotary work piece unless specifically recited in the claims.

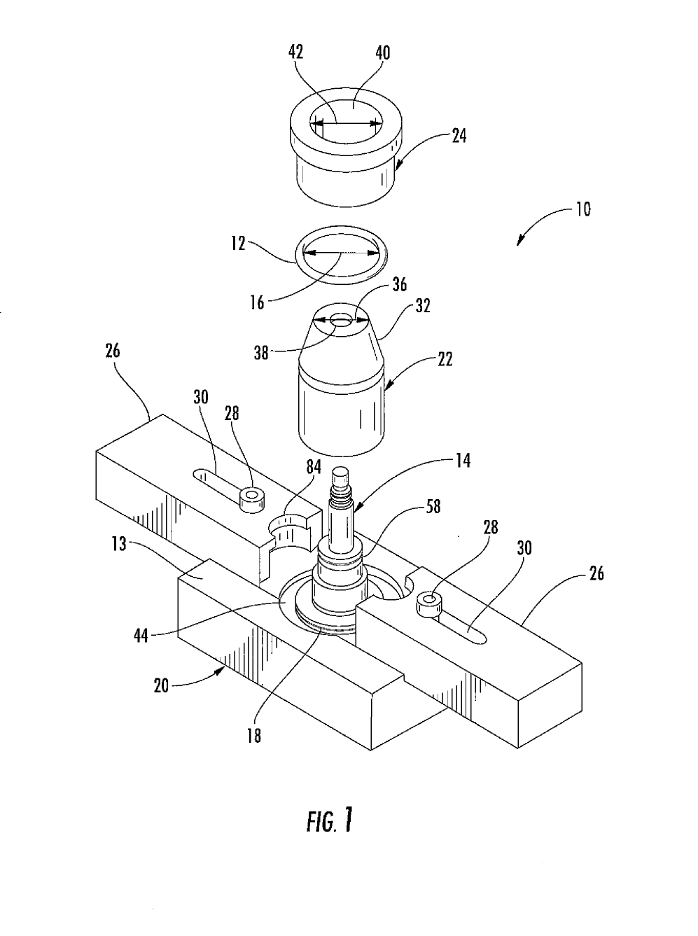

Referring now to the drawings, wherein identical numerals indicate the same elements throughout the figures, FIG. 1 provides a perspective view of a system 10 for installing a first seal 12 on a work piece 14 according to one embodiment of the present invention. The first seal 12 may be an O-ring, a K-ring, or similar device having a relaxed diameter 16 and suitable elastic properties to stretch over an outer surface of the work piece 14. As shown in FIG. 1, the work piece 14 may include a first groove 18 or other detent to facilitate proper placement and enhance retention of the first seal 12. Although the exemplary first seal 12 and first groove 18 are shown as circular or toroidal, the first seal 12 and first groove 18 may be square, triangular, or any geometric shape, depending on the particular work piece 14.

In the particular embodiment shown in FIG. 1, the system 10 may include a platform 20 for positioning and/or holding the work piece 14, a first stretcher tool 22 for stretching the first seal 12, and a first collar 24 for pushing the first seal 12 along the first stretcher tool 22 and into the first groove 18 in the work piece 14. The platform 20 may include one or more reciprocating members 26 attached to the platform 20 so that the reciprocating members 26 may move toward or away from the work piece 14. For example, as shown in FIG. 1, a pin 28 may extend through each reciprocating member 26 to the platform 20, and a slot 30 in each reciprocating member 26 may provide a guide for the pin 28 to allow reciprocating movement between the reciprocating members 26 and the platform 20. In this manner, each reciprocating member 26 may have a first position separated from the work piece 14, as shown in FIG. 1, and a second position in contact with the work piece 14, as will be described later with respect to FIGS. 8-13.

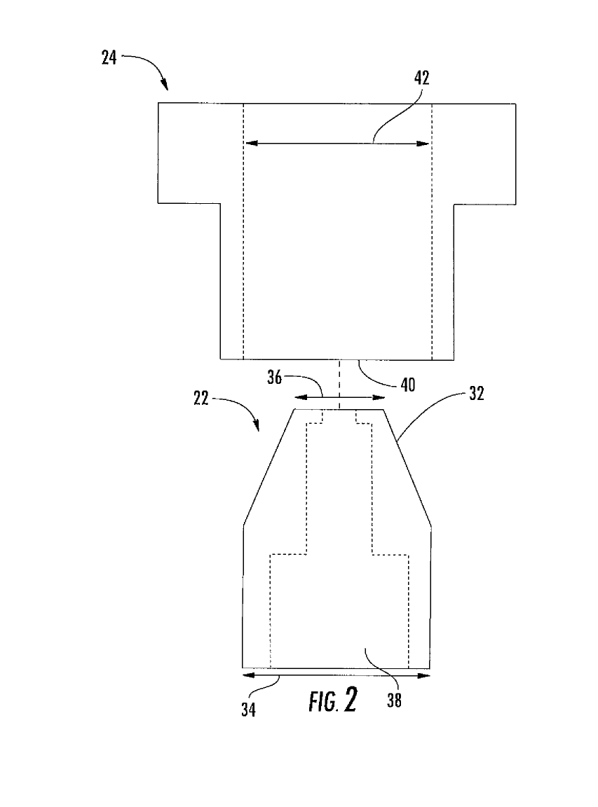

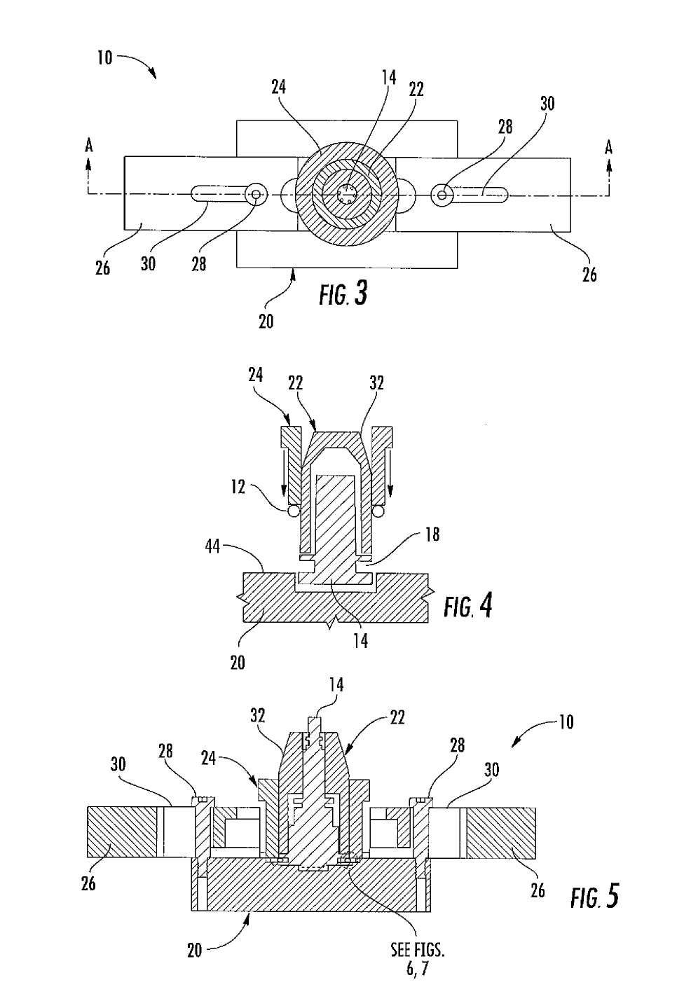

FIG. 2 provides a side plan view of the first stretcher tool 22 and first collar 24 shown in FIG. 1. As shown in FIG. 2, the first stretcher tool 22 may include a tapered end 32 and a stretcher outer diameter 34 opposite the tapered end 32. The tapered end 32 generally has an outer diameter 36 that is slightly less than the relaxed diameter 16 of the first seal 12, and the stretcher outer diameter 34 is generally larger than the relaxed diameter 16 of the first seal 12. In this manner, the first seal 12 may be placed or slid onto the tapered end 32 of the stretcher tool 22 and gradually stretched as the first seal 12 slides over the stretcher outer diameter 34. As further shown in phantom in FIG. 2, the first stretcher tool 22 may include a stretcher axial bore 38 that allows the first stretcher tool 22 to fit over the work piece 14, as will be described with respect to FIGS. 4 and 5. The first collar 24 may also include an axial bore 40 with a collar inner diameter 42 that is slightly greater than the stretcher outer diameter 34. In this manner, the first collar 24 is adapted to slide over the stretcher outer diameter 34 to push the first seal 12 over the stretcher outer diameter 34.

FIG. 3 provides a top plan view of the system 10 shown in FIG. 1, and FIGS. 4 and 5 provide cross-section views of the system 10 shown in FIG. 3 taken along line A-A during installation of the first seal 12. As shown in FIGS. 3-5, each reciprocating member 26 is in the first position separated from the work piece 14, and the stretcher axial bore 38 allows the first stretcher tool 22 to fit over the work piece 14. Referring to FIG. 4, the relaxed diameter 16 of the first seal 12 fits over the tapered end 32 of the first stretcher tool 22, and the first seal 12 may be slid along the tapered end 32 to gradually stretch the first seal 12 to match the stretcher outer diameter 34. If desired, a soap or other lubricant may be applied to the stretcher outer diameter 34 to reduce friction between the first seal 12 and the stretcher outer diameter 34. As shown in FIG. 5, the axial bore 40 of the first collar 24 allows the first collar 24 to fit over the first stretcher tool 22, and the first collar 24 may push the first seal 12 across the stretcher outer diameter 34 as the collar inner diameter 42 slides across the stretcher outer diameter 34.

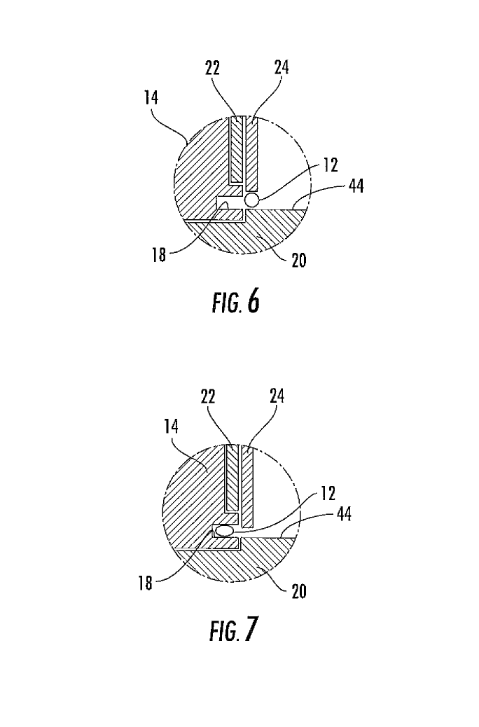

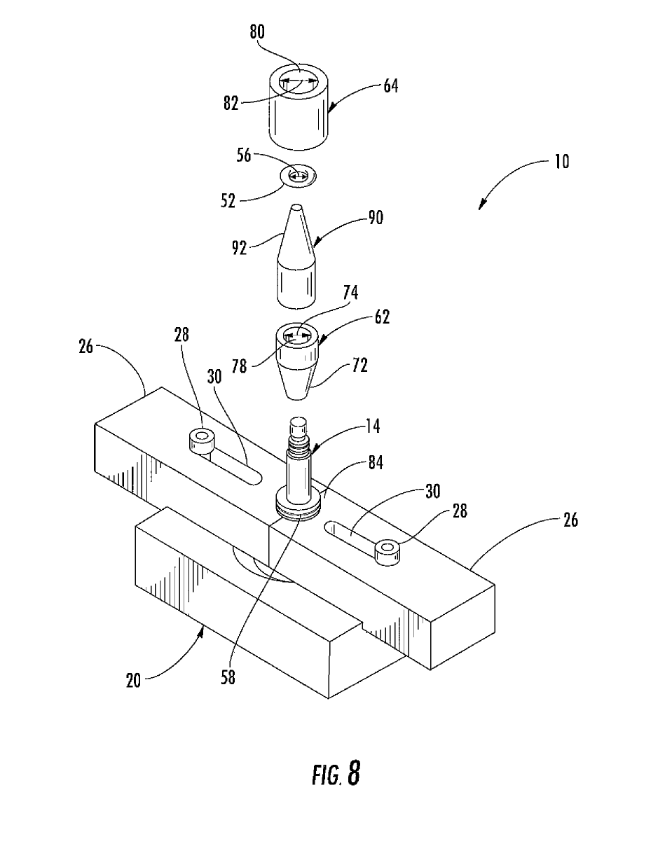

As shown most clearly in FIGS. 4 and 5, the platform 20 may define a first surface 44 that is substantially co-planar with the first groove 18 in the work piece 14. As a result, the first collar 24 may push the first seal 12 along the stretcher outer diameter 34 until the first seal 12 reaches the first groove 18 and/or the first surface 44 of the platform 20, as shown in the enlarged view of FIG. 6. Once aligned with the first groove 18, the first seal 12 may elastically retract into the first groove 18, as shown in the enlarged view of FIG. 7. In this manner, the platform 20, first stretcher tool 22, and first collar 24 facilitate accurate placement of the first seal 12 in the first groove 18 without twisting, bending, or otherwise distorting the first seal 12 during installation.

FIG. 8 provides a perspective view of additional components of the system 10 that may be included for installing a second seal 52 on the work piece 14. The second seal 52 may be an O-ring, a K-ring, or similar device having a relaxed diameter 56 and suitable elastic properties to stretch over an outer surface of the work piece 14. As shown in FIG. 8, the work piece 14 may include a second groove 58 or other detent to facilitate proper placement and enhance retention of the second seal 52. Although the exemplary second seal 52 and second groove 58 are shown as circular or toroidal, the second seal 52 and second groove 58 may be square, triangular, or any geometric shape, depending on the particular work piece 14.

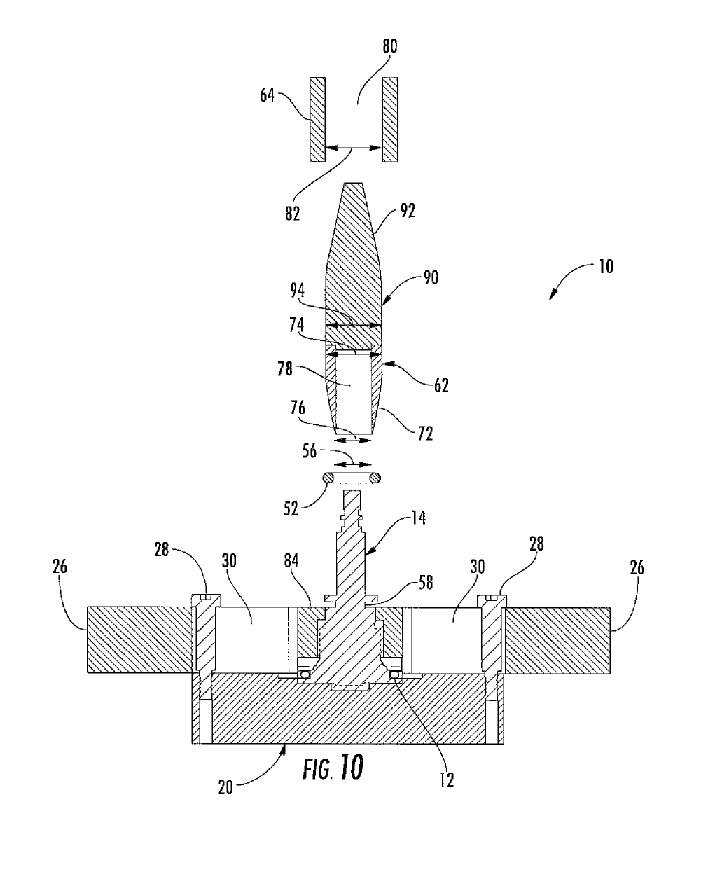

As shown in FIG. 8, the system 10 again includes the platform 20 with reciprocating members 26 for positioning and/or holding the work piece 14 as previously described with respect to FIGS. 1-7. In addition, the system 10 may include a second stretcher tool 62 for stretching the second seal 52 and a second collar 64 for pushing the second seal 52 along the second stretcher tool 62 and into the second groove 58 in the work piece 14. The second stretcher tool 62 may again include a tapered end 72 and a stretcher outer diameter 74 opposite the tapered end 72. The stretcher outer diameter 74 of the second stretcher tool 62 may be slightly smaller than the stretcher outer diameter 34 of the first stretcher tool 22 to accommodate a smaller second seal 52. In addition, the tapered end 72 generally has an outer diameter 76 that is slightly less than the relaxed diameter 56 of the second seal 52, and the stretcher outer diameter 74 is generally larger than the relaxed diameter 56 of the second seal 52. In this manner, the second seal 52 may be placed or slid onto the tapered end 72 of the second stretcher tool 62 and gradually stretched as the second seal 52 slides over the stretcher outer diameter 74. As further shown in FIG. 8, the second stretcher tool 62 may include a stretcher axial bore 78 that allows the second stretcher tool 62 to fit over the work piece 14, as will be described with respect to FIGS. 10 and 11. The second collar 64 may also include an axial bore 80 with a collar inner diameter 82 that is slightly greater than the stretcher outer diameter 74. In this manner, the second collar 64 is adapted to slide over the stretcher outer diameter 74 to push the second seal 52 over the stretcher outer diameter 74.

As further shown in FIG. 8, the system 10 may also include an adapter 90 to facilitate placement of the second seal 52 on the second stretcher tool 62. The adapter 90 may have a tapered adapter end 92 and an adapter outer diameter 94 opposite the tapered adapter end 92 that is substantially equal to the stretcher outer diameter 74 of the second stretcher tool 62. In this manner, the second seal 52 may be placed or slid onto the tapered adapter end 92 and gradually stretched as the second seal 52 slides over the adapter outer diameter 94 and onto the stretcher outer diameter 74.

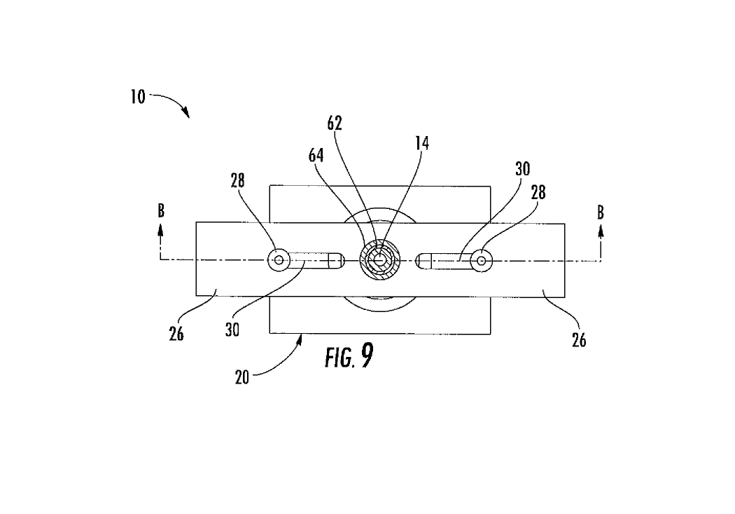

FIG. 9 provides a top plan view of the system 10 shown in FIG. 8, and FIGS. 10 and 11 provide cross-section views of the system 10 shown in FIG. 9 taken along line 13 B during installation of the second seal 52. As shown in FIGS. 9-11, each reciprocating member 26 is in the second position in contact with the work piece 14. Referring to FIG. 10, the relaxed diameter 56 of the second seal 52 fits over the tapered adapter end 92, and the second seal 52 may be slid along the tapered adapter end 92 to gradually stretch the second seal 52 to match the stretcher outer diameter 74 of the second stretcher tool 62. If desired, a soap or other lubricant may be applied to the adapter 90 and/or second stretcher tool 62 to reduce friction between the second seal 52 and the adapter 90 and/or second stretcher tool 62.

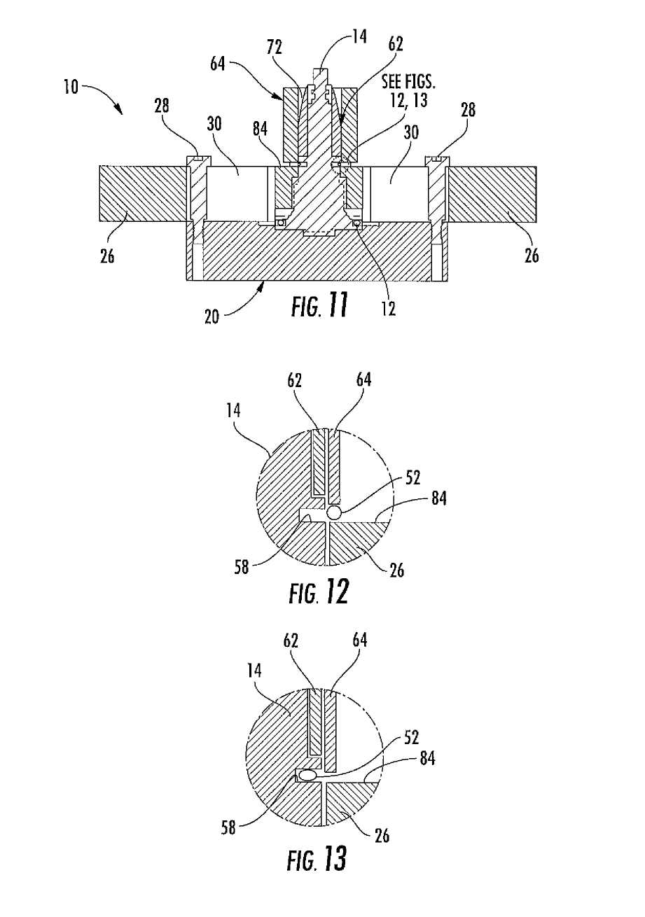

As shown in FIG. 11, the stretcher axial bore 78 allows the second stretcher tool 62 to fit over the work piece 14, and the axial bore 80 of the second collar 64 allows the second collar 64 to fit over the second stretcher tool 62. The second collar 64 may push the second seal 52 across the stretcher outer diameter 74 as the second collar inner diameter 82 slides across the stretcher outer diameter 74. As shown most clearly in FIGS. 10 and 11, the platform 20 may define a second surface 84 that is substantially co-planar with the second groove 58 in the work piece 14. As a result, the second collar 64 may push the second seal 52 along the stretcher outer diameter 74 until the second seal 52 reaches the second groove 58 and/or the second surface 84 of the platform 20, as shown in the enlarged view of FIG. 12. Once aligned with the second groove 58, the second seal 52 may elastically retract into the second groove 58, as shown in the enlarged view of FIG. 13. In this manner, the platform 20, second stretcher tool 62, and second collar 64 facilitate accurate placement of the second seal 52 in the second groove 58 without twisting, bending, or otherwise distorting the second seal 52 during installation.

The system 10 described and illustrated in FIGS. 1-13 may also provide a method for installing the first and/or second seals 12, 52 on the work piece 14. The method may include placing the work piece 14 in the platform 20, wherein the platform 14 defines the first surface 44 substantially co-planar with the first groove 18 in the work piece 14. In particular embodiments, the platform 20 may further include the reciprocating members 26 having the first position separated from the work piece 14 and the second position in contact with the work piece 14. Alternately or in addition, the platform 20 may define the second surface 84 substantially co-planar with the second groove 58 in the work piece 14 when the reciprocating members 26 are in the second position.

The method may further include placing the first or second seal 12, 52 on the stretcher tool 22, 62 and placing the stretcher tool 22, 62 on the work piece 14. In particular embodiments, the method may include sliding the seal 12, 52 over the adapter 90 onto the stretcher tool 22, 62. The method may further include sliding the collar 24, 64 over the tapered end 32, 72 and stretcher outer diameter 34, 74 to push the seal 12, 52 over the stretcher outer diameter 34, 74 and into the groove 18, 58 in the work piece 14.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal language of the claims.

What is claimed is:

1. A system for installing a seal on a work piece, the system comprising:
a. a stretcher tool;
b. a tapered end of said stretcher tool;
c. a stretcher outer diameter opposite said tapered end;
d. a stretcher axial bore opposite said tapered end;
e, a collar having a collar inner diameter greater than said stretcher outer diameter; and
f. wherein said collar is adapted to slide over said stretcher outer diameter to push the seal over said stretcher outer diameter.

2. The system as in claim 1, wherein said stretcher outer diameter is larger than a relaxed diameter of the seal.

3. The system as in claim 1, further comprising an adapter having a tapered adapter end, an adapter outer diameter opposite said tapered adapter end, and wherein said adapter outer diameter is substantially equal to said stretcher outer diameter.

4. The system as in claim 1, further comprising a platform and a plurality of reciprocating members attached to said platform.

5. The system as in claim 4, wherein said platform defines a first surface substantially co-planar with a first groove in the work piece.

6. The system as in claim 4, wherein said plurality of reciprocating members have a first position separated from the work piece and a second position in contact with the work piece.

7. The system as in claim 6, wherein said reciprocating members define a second surface substantially co-planar with a second groove in the work piece when said reciprocating members are in said second position.

8. A system for installing first and second seals in first and second grooves, respectively, on a work piece, the system comprising:
a. a first stretcher tool having a first tapered end, a first stretcher outer diameter opposite said first tapered end, and a first stretcher axial bore opposite said first tapered end;
b. a second stretcher tool having a second tapered end, a second stretcher outer diameter opposite said second tapered end, and a second stretcher axial bore opposite said second tapered end;
c. a first collar having a first collar inner diameter greater than said first stretcher outer diameter;
d. a second collar having a second collar inner diameter greater than said second stretcher outer diameter;
e. wherein said first stretcher outer diameter is greater than said second stretcher outer diameter; and
f. wherein said first collar is adapted to slide over said first stretcher outer diameter to push the first seal over said first stretcher outer diameter, and said second collar is adapted to slide over said second stretcher outer diameter to push the second seal over said second stretcher outer diameter.

9. The system as in claim 8, wherein said first stretcher outer diameter is larger than a relaxed diameter of the first seal.

10. The system as in claim 8, further comprising an adapter having a tapered adapter end, an adapter outer diameter opposite said tapered adapter end, and wherein said adapter outer diameter is substantially equal to said second stretcher outer diameter.

11. The system as in claim 8, further comprising a platform and a plurality of reciprocating members attached to said platform.

12. The system as in claim 11, wherein said platform defines a first surface substantially co-planar with a first groove in the work piece.

13. The system as in claim 11, wherein said plurality of reciprocating members have a first position separated from the work piece and a second position in contact with the work piece.

14. The system as in claim 13, wherein said reciprocating members define a second surface substantially co-planar with a second groove in the work piece when said reciprocating members are in said second position.

15. A method for installing a seal on a work piece, the method comprising:
a. placing the seal on a stretcher tool, wherein said stretcher tool has a tapered end, a stretcher outer diameter opposite said tapered end, and a stretcher axial bore opposite said tapered end;
b. sliding a collar over said tapered end and said stretcher outer diameter;
c. engaging said collar against the seal; and
d. sliding said collar over said stretcher outer diameter to push the seal over said stretcher outer diameter and into a first groove in the work piece.

16. The method as in claim 15, further comprising placing the work piece in a platform wherein said platform defines a first surface substantially co-planar with the first groove in the work piece.

17. The method as in claim 15, further comprising placing the work piece in a platform having a plurality of reciprocating members attached to said platform, wherein said plurality of reciprocating members have a first position separated from the work piece and a second position in contact with the work piece.

18. The method as in claim 17, further comprising moving said reciprocating members to said second position wherein said reciprocating members define a second surface substantially co-planar with a second groove in the work piece when said reciprocating members are in said second position.

19. The method as in claim 15, further comprising sliding the seal over an adapter onto said stretcher tool, wherein said adapter has a tapered adapter end, an adapter outer diameter opposite said tapered adapter end, and said adapter outer diameter is substantially equal to said stretcher outer diameter.
